(19) United States
(12) Patent Application Publication
(10) Pub. No.: US 2018/0124868 A1
(43) Pub. Date: May 3, 2018

(54) METHODS FOR IMPROVING PERFORMANCE AND REDUCING POWER CONSUMPTION IN A DSDS DEVICE

(71) Applicant: Samsung Electronics Co., Ltd., Suwon-si (KR)

(72) Inventors: Ashish Kumar GUPTA, Bangalore (IN); Balaji Srinivasan Thiruvenkatachari, Bangalore (IN); Swapnil Vinod Khachane, Bangalore (IN)

(73) Assignee: Samsung Electronics Co., Ltd., Suwon-si (KR)

(21) Appl. No.: 15/789,396

(22) Filed: Oct. 20, 2017

(30) Foreign Application Priority Data
Oct. 27, 2016 (IN) 201641036956

(51) Int. Cl. H04W 88/06; H04W 36/36; H04W 52/02; H04W 8/18; H04W 60/04

(52) U.S. Cl. CPC H04W 88/06; H04W 36/36; H04W 60/04; H04W 52/0232; H04W 8/183; H04W 52/0245

(57) ABSTRACT

The present invention provides methods for improving performance and reducing power consumption in a dual subscriber identification module (SIM) dual standby (DSDS) device. According to one example embodiment, the DSDS device enhances the usage of a single RF resource to be shared between a first SIM and a second SIM of the DSDS device based on one or more entry and exit conditions. The DSDS device allows the first SIM to use the RF resource for a data session while it restricts the second SIM from performing neighbor cell measurements when entry conditions are met. By restricting the neighbour cell measurement operations on the second SIM, the DSDS device enables the first SIM to use the RF resource for an extended time thereby improving data rates in the DSDS device. Further, the DSDS device allows the second SIM to perform neighbor cell measurements when the exit conditions are met.

### PRIORITY

This application claims priority under 35 U.S.C. § 119(a) to Indian Complete Patent Application Serial No. 201641036956 (CS), which was filed on Oct. 27, 2016 in the Indian Intellectual Property Office, the entire disclosure of this application is incorporated herein by reference.

### TECHNICAL FIELD

The present invention generally relates to wireless communication devices and methods, and more particularly relates to methods for improving performance and reducing power consumption in a dual subscriber identification module (SIM) dual standby (DSDS) device.

### BACKGROUND

Wireless communication devices containing more than one subscriber identification module (SIM), also known as “multi-SIM wireless devices,” have become more popular because of the flexibility in service options and other features such multi-SIM wireless devices provide. For example, various wireless networks may be configured to handle different types of data, use different communication modes, implement different radio access technologies, etc.

One type of multi-SIM wireless device, referred to as a dual-SIM dual-standby (DSDS) device, shares a common RF resource between two SIMs, thereby allowing selective communication on a first network while listening for pages on a second network. Further, multi-SIM devices may have more than two SIMs (e.g., tri-SIM, quad-SIM, etc.). For example, another type of multi-SIM wireless device, a tri-SIM tri-standby (TSTS) device, may share a common RF resource between all three SIMs, allowing selective communication on a first network while listening for pages on a second network and a third network.

A DSDS device has two SIMs that share a common RF resource for their respective activities. For example, a first SIM, SIM 1, may correspond to long-term evolution (LTE) radio access technology (RAT) and a second SIM, SIM 2, may correspond to second generation (2G) RAT. Since the common RF resource is shared, while SIM 2 uses the RF resource for performing periodic measurements of serving and neighbour cells for its idle mode mobility purposes, SIM 1 may be unable to perform RX/TX on an LTE carrier for a relatively long time.

In view of the foregoing, it would be desirable to create a mechanism for reducing the periodic measurements on SIM 2 in such a way that SIM 1's data performance is not affected while not causing SIM 2 to lose the serving cell.

### SUMMARY

Various example embodiments herein describe methods for operating by a dual subscriber identification module (SIM) dual standby (DSDS) device. According to several example embodiments, the methods include determining whether one or more entry conditions for restricting a use of the second SIM used to perform neighbour cell search and measurement operations are detected when the first SIM is used to perform data communication. The methods further include imposing restrictions on the use of the second SIM in response to detecting the one or more entry conditions. The methods further include determining whether one or more exit conditions to remove the restrictions on the use of the second SIM are detected. Furthermore, the methods include removing the restrictions on the use of the second SIM in response to detecting the one or more exit conditions. According to example embodiments, while the restrictions are imposed on the use of the second SIM, the first SIM is used to the data communication using a radio frequency (RF) resource that is shared for the first SIM and the second SIM.

According to example embodiments, the one or more entry conditions for restricting the use of the second SIM include at least one of: a first condition that the first SIM is used in a connected mode to perform data transfer operations, a second condition that the first SIM is used in a connected mode while a data transfer speed is above a first threshold value, a third condition that the second SIM is used while a signal strength of a serving cell greater than a second threshold value, and a fourth condition that the first SIM includes information configured by a network with measurement including a network identity associated with the first SIM or the second SIM. According to example embodiments, the second threshold value is an implementation specific threshold value being chosen so as not to affect the second SIM performance.

According to example embodiments, the use of the second SIM is restricted when a signal strength of a serving cell associated with the second SIM is greater than a threshold value and an additional RF resource is required to perform a data transfer associated with the first SIM.

According to example embodiments, the one or more exit conditions to remove the restrictions on the use of the second SIM include at least one of: a first condition that an idle mode is entered after completing a data transfer operation using the first SIM, a second condition that a data transfer speed requirement is below a first threshold value in a connected mode using the first SIM, a third condition that a signal strength of a serving cell associated with the second SIM is less than a second threshold value, a fourth condition that a serving cell measurement event is triggered on the first SIM for a network or cell measurement IDs added by the network in a measurement configuration, a fifth condition that a change in a cell ID occurring due to a handover or redirection operation associated with the first SIM, and a sixth condition that a threshold time being exceeded by a duration during which the restrictions are imposed on the use of the second SIM.

According to example embodiments, the first SIM and the second SIM are adapted to operate on at least one of: a global system for mobile communication (GSM) network, a universal mobile telecommunications system (UMTS) network, a long term evolution (LTE) network, and a LTE-Advanced (4G) network.

Various example embodiments herein further describe a dual subscriber identification module (SIM) dual standby (DSDS). According to example embodiments, the DSDS device includes a memory, a first SIM configured to store information for availing first services from a first network, a second SIM configured to store information for availing second services from a second network, and a controller operatively coupled to the memory, the first SIM and the second SIM. Further, the controller is configured to determine whether one or more entry conditions for restricting a use of the second SIM used to perform neighbour cell search and measurement operations are detected when the first SIM is used to perform data communication related to the first network. The controller is further configured to impose restrictions on the use of the second SIM in response to detecting the one or more entry conditions. Further, the controller is configured to determine whether one or more exit conditions to remove the restrictions on the use of the second SIM are detected. Further, the controller is configured to remove the restrictions on the use of the second SIM in response to detecting the one or more exit conditions. According to example embodiments, while the restrictions are imposed on the use of the second SIM, the first SIM is used to the data communication using a radio frequency (RF) resource that is shared for the first SIM and the second SIM.

Example embodiments provide for methods for a dual subscriber identification module (SIM) dual standby (DSDS) device including a first SIM and a second SIM. The methods include detecting whether a signal strength of a serving cell associated with the second SIM is greater than a threshold value when the first SIM is used to perform data communication with a first network. The methods further include imposing restrictions on a use of the second SIM used to perform neighbour cell search and measurement operations in response to detecting the signal strength of the serving cell is greater than the threshold value. The methods further include detecting whether the first SIM is in an idle state. Furthermore, the methods include removing the restrictions on the use of the second SIM in response to detecting the use of the first SIM is in the idle state. According to example embodiments, while the restrictions are imposed on the use of the second SIM, the first SIM is used to the data communication using a radio frequency (RF) resource that is shared for the first SIM and the second SIM.

The foregoing has outlined, in general, the various aspects of the invention and is to serve as an aid to better understand the more complete detailed description which is to follow. In reference to such, there is to be a clear understanding that the present invention is not limited to the method or application of use described and illustrated herein. It is intended that any other advantages and objects of the present invention that become apparent or obvious from the detailed description or illustrations contained herein are within the scope of the present invention.

### BRIEF DESCRIPTION OF THE DRAWINGS

The other objects, features and advantages will occur to those skilled in the art from the following description of the example embodiments and the accompanying drawings in which:

FIG. 1 illustrates an overall system diagram according to example embodiments.

FIG. 2 is a flow chart illustrating a process of enhancing data performance in a first SIM of a dual SIM dual standby (DSDS) device, according to example embodiments.

FIG. 3 is a flow chart illustrating a process for restricting cell measurements in a second SIM when a data session is ongoing in a first SIM, according to example embodiments.

FIG. 4 is a block diagram illustrating functional components of a DSDS device, according to example embodiments.

Although specific features of the present invention are shown in some drawings and not in others, this is done for convenience only as each feature may be combined with any or all of the other features in accordance with the present invention.

### DETAILED DESCRIPTION

Various example embodiments disclose methods for improving data performance and reducing power consumption in a DSDS device. In the following detailed description, reference is made to the accompanying drawings that form a part hereof, and in which are shown by way of illustration example embodiments in which the invention may be practiced. These example embodiments are described in sufficient detail to enable those skilled in the art to practice the invention, and it is to be understood that other example embodiments may be utilized and that changes may be made without departing from the scope of the present invention. The following detailed description is, therefore, not to be taken in a limiting sense, and the scope of the present invention is defined only by the appended claims.

The specification may refer to “an”, “one” or “some” example embodiment(s) in several locations. This does not necessarily imply that each such reference is to the same example embodiment(s), or that the feature only applies to a single example embodiment. Single features of different example embodiments may also be combined to provide other example embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features, integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Methods are provided for improving data performance and reducing power consumption in a DSDS device. Various example embodiments are described in the present disclosure to describe the working of the methods, but do not limit the scope of the present invention.

The example embodiments herein and the various features and details thereof are explained more fully with reference to the non-limiting example embodiments that are illustrated in the accompanying drawings and detailed in the following description. Descriptions of well-known components and processing techniques are omitted so as to not unnecessarily obscure the example embodiments herein. The examples used herein are intended merely to facilitate an understanding of ways in which the example embodiments herein can be practiced and to further enable those of skill in the art to practice the example embodiments herein. Accordingly, the examples should not be construed as limiting the scope of the example embodiments herein.

Throughout the description the terms “first SIM” and “SIM 1” are interchangeably used. Similarly, the terms “second SIM” and “SIM 2” are interchangeably used.

Methods are described for improving performance and reducing power consumption in a dual SIM dual standby (DSDS) device. As the name recites, the DSDS device is capable of accommodating two SIMs, namely a first SIM and a second SIM, in a single device and allows a single radio frequency (RF) resource to be shared between them. In example embodiments, the first SIM is capable of providing packet switched (PS) services in a long term evolution (LTE) network, whereas the second SIM is capable of providing circuit switched services in a 2G network. In example embodiments, the first SIM is capable of providing call services in a 2G network, whereas the second SIM is capable of providing PS services in an LTE network.

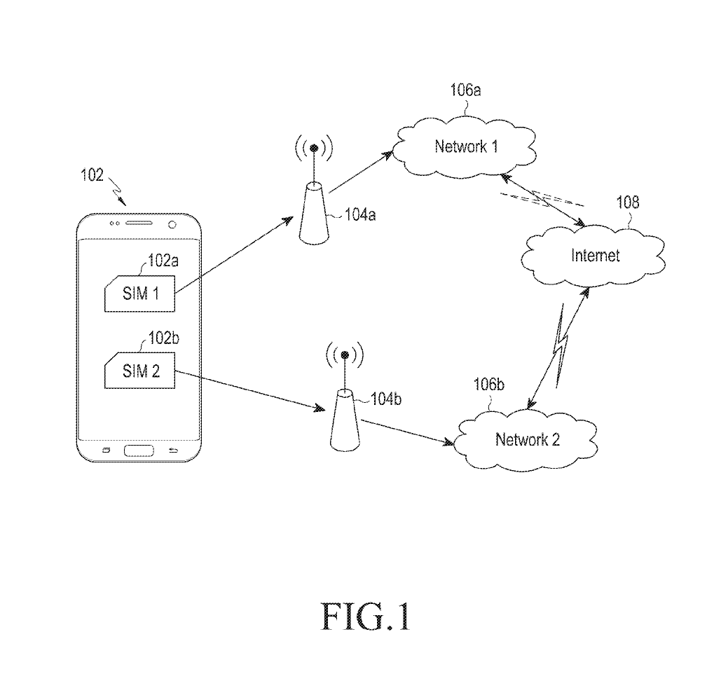

FIG. 1 illustrates an overall system diagram according to example embodiments. As shown in FIG. 1, the system includes a DSDS device 102 having two SIMs: SIM 102a (depicted as “SIM 1”) and SIM 102b (depicted as “SIM 2”), wherein SIM 102a is connected to a first network 106a (depicted as “Network 1”) via a first base station 104a and SIM 102b is connected to a second network 106b (depicted as “Network 2”) via a second base station 104b. SIM 102b is connected to Internet 108 in order to provide packet data services to DSDS device 102. For illustration purposes, second network 106b is shown as having direct connection with Internet 108 as SIM 102b is subscribed for data packet services from second network 106b, whereas SIM 102a is not subscribed for data services and hence connection between first network 106a and Internet 108 is shown in dotted lines.

In an example embodiment, consider that SIM 102a is in an active data session with first network 106a. In this case, the RF resources are used by SIM 102a for receiving data services from Internet 108 via first network 106a. In this situation, SIM 102b operates in idle mode. However, while SIM 102b is in idle mode, SIM 102b desires RF resources for performing periodic measurements of serving and neighbour cells for mobility purposes. While SIM 102b is performing periodic measurements of serving and neighbour cells, SIM 102a may be unable to perform transmission/reception in first network 106a for a relatively long time. Under such circumstances, the RF resources may not be efficiently utilized for SIM 102a. The issue is addressed by restricting serving/neighbour cell search operations in SIM 102b in order to enhance data performance in SIM 102a based on certain conditions. A DSDS controller in the DSDS device monitors the conditions and enables the effective utilization of RF resources for data performance. The DSDS controller restricts the operation of SIM 102b so that the RF resources may be utilized for a longer time by SIM 102a.

According to example embodiments, SIM 102a and SIM 102b are configured to operate on at least one of: a global system for mobile communication (GSM) network; a universal mobile telecommunications system (UMTS) network, a long term evolution (LTE) network, and an LTE-Advanced (4G) network.

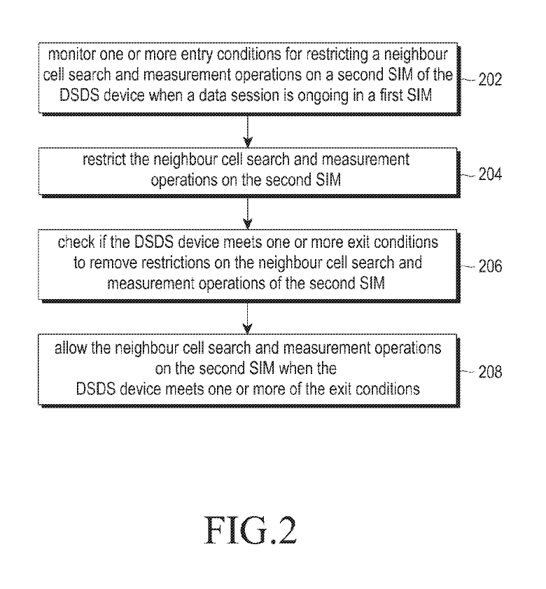

FIG. 2 is a flow chart illustrating a process of improving performance in a first SIM of a dual SIM dual standby (DSDS) device, according to example embodiments. In order to enhance data performance in a first SIM, a DSDS controller restricts operations to be performed in a second SIM based on one or more conditions. At operation 202, the DSDS controller monitors one or more entry conditions for restricting a neighbour cell search and measurement operations on the second SIM of the DSDS device when a data session is ongoing in the first SIM. The one or more entry conditions may be satisfied to impose cell measurement restrictions in the second SIM.

The one or more entry conditions corresponds to at least one of: the first SIM is in a connected mode to perform data transfer operations, the first SIM is in a connected mode and the data transfer speed is above a threshold value, the second SIM receives a signal strength of a serving cell greater than a threshold received signal strength indicator (RSSI) value, and the first SIM includes information configured by a network with measurements including network identities of different radio access technologies (RATs). According to example embodiments, the set threshold RSSI value is an implementation specific threshold value that is chosen so as not to affect the performance of the second SIM. If any of the above conditions are satisfied, then at operation 204, the neighbour cell search and measurement operations on the second SIM are restricted. Thus, the RF resources are shared with the first SIM.

Similarly, it is checked at operation 206, whether one or more exit conditions are met to allow the neighbour cell search and measurement operations on the second SIM. The one or more exit conditions include at least one of: the first SIM entering an idle mode after completing the data transfer operation, the data transfer speed parameter is below a threshold value when the first SIM is in a connected mode, the RSSI value of the serving cell of the second SIM falls below a threshold RSSI value, a measurement event is triggered on the first SIM for the configured networks such as a measurement event where LTE or GSM cell measurement IDs are added by the network during a measurement configuration, change in a cell ID due to a handover or redirection operation performed by the first SIM, and elapse of a threshold time due to restrictions on the operations of the second SIM. When any of the exit conditions are met, then at operation 208, the neighbour cell search and measurement operations restrictions are removed on the second SIM. Thus, the restriction of neighbour cell search measurement operations on the second SIM enables the first SIM to use a radio frequency (RF) resource for an extended time thereby improving data rates in the first SIM of the DSDS device. It is to be noted that restricting cell measurements in the second SIM not only enhances data performance but also reduces power consumption in the DSDS device.

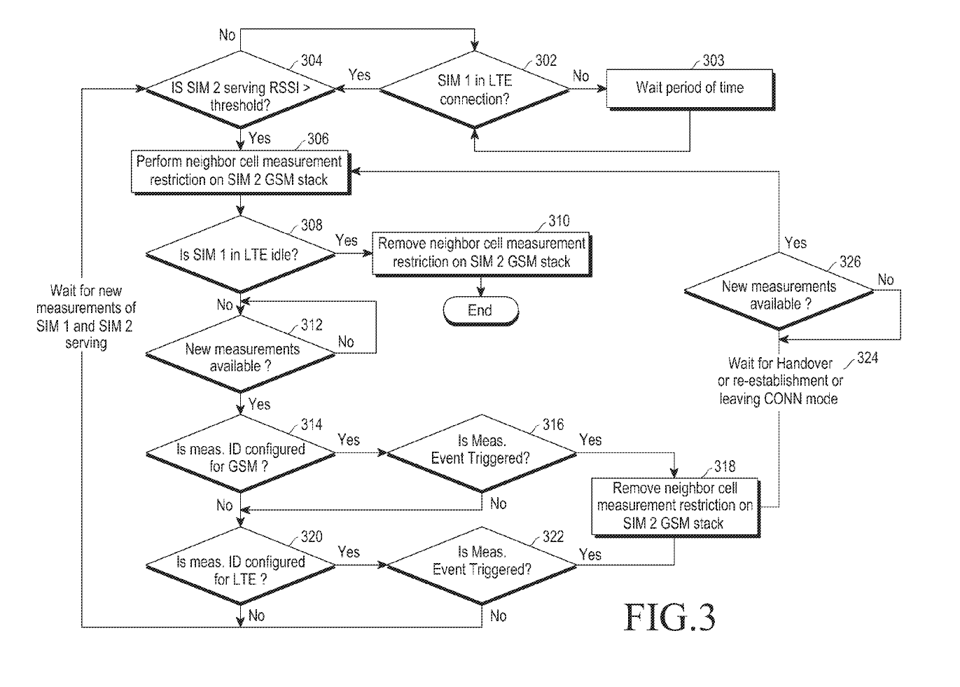

FIG. 3 is a flow chart illustrating a process for restricting cell measurements in a second SIM when a data session is ongoing in a first SIM, according to example embodiments. In these example embodiments, consider that the first SIM operates in an LTE network and the second SIM operates in a GSM network. A potential conflict may emerge when the first SIM performs a data session using the LTE network and utilizes RF resources for the data session. The second SIM may attempt to utilize the same RF resources when it is in idle mode for mobility purposes. In order to effectively use the RF resources in the first SIM, it may be desired that the second SIM be restricted from performing cell measurements. However, it is also desired that restricting cell measurements not affect call performance in the second SIM. Therefore, rather than restricting all cell measurements in the second SIM, it is important to determine when to enable and disable cell measurement restrictions in the second SIM.

The enabling and disabling of cell measurement restrictions are also performed based on identification of one or more conditions. A DSDS controller in the DSDS device monitors the one or more conditions for enabling and disabling neighbour cell measurement restrictions in the second SIM. Thus, the one or more conditions for enabling neighbour cell measurement restrictions and the one or more conditions for disabling neighbour cell measurement restrictions are analogous to each other. The conditions for enabling cell restrictions are called entry conditions, whereas conditions for disabling cell restrictions are called exit conditions. Both the entry and exit conditions are explained further in association with FIG. 3.

As shown in FIG. 3, the DSDS controller checks, at operation 302, whether the first SIM (SIM 1) is connected with an LTE network for performing a data session. If SIM 1 is connected with an LTE network, then at operation 304, the DSDS controller is determined whether a received signal strength indication (RSSI) of a serving cell in the second SIM (SIM 2) is greater than a threshold value. If, at operation 302, it is determined that SIM 1 is not connected with the LTE network, the DSDS controller waits a period of time at operation 303. And, the DSDS controller again checks whether SIM 1 is connected with the LTE network at operation 302 after the period of time. If the determination of operation 304 is “yes”, at operation 306, neighbour cell measurements are restricted in a SIM 2 GSM stack. Hence, the RF resource is to be utilized for SIM 1 alone. If the determination of operation 304 is “no”, the process returns to operation 302 to check whether SIM 1 is connected with the LTE network. Following the completion of operation 306, at operation 308, it is determined whether SIM 1 in the LTE network is in an idle state. If the determination of operation 308 is that SIM 1 is in the idle state, at operation 310, cell measurement restrictions are removed from SIM 2. If it is determined in operation 308 that SIM 1 in connection with the LTE network is not in the idle state, it is further determined at operation 312, whether new measurement results are available for SIM 1 from the network. According to example embodiments, operation 312 in which it is determined whether new measurement results are available is referred to as a non-idle measurement check. If it is determined at operation 312 that new measurement results are not available, the DSDS controller waits a period of time before checking again. If the determination of operation 312 is “yes”, the process advances to operation 314.

The new measurement results are configured by the network to indicate which neighbour cells to measure and when to perform measurement. The measurement IDs configured by the network enable the DSDS device to maintain better connection with the network. The network configures SIM 1 with measurement cell IDs belonging to different radio access technologies (RAT) cells such as LTE, GSM, etc. in order to avail services from the network. Therefore, at operation 314, it is determined whether the measurement IDs of SIM 1 are configured for GSM. If the determination of operation 314 is “yes”, at operation 316, it is further checked whether any event is triggered to perform measurement on the configured GSM cell. If a measurement event is triggered, at operation 318, neighbour cell measurement restrictions are removed from the SIM 2 GSM stack and the RF resources are used by SIM 2 for neighbour cell measurements.

As depicted in operation 314, if the measurement ID is not configured for GSM, then it is determined at operation 320, whether the measurement IDs of SIM 1 are configured for an LTE cell. If the determination of operation 320 is “yes”, at operation 322, it is further determined whether any event is triggered to perform measurement on the configured LTE cell. If the measurement event is triggered, at operation 318, the neighbour cell measurement restrictions are removed from the SIM 2 GSM stack. Hence, if measurement events are triggered at SIM 1 for either of an LTE or GSM cell, then the DSDS device removes neighbour cell measurement restrictions on the SIM 2 GSM stack. However, if measurement events are not triggered for either an LTE or GSM cell, then the DSDS device waits for new measurement results from the network for both SIM 1 and SIM 2 serving cells respectively. According to example embodiments, the operation in which the DSDS device waits for new measurement results is referred to a post-configuration measurement check. Once new measurement results are received from the network, the process returns to operation 304 to determine whether a RSSI of a serving cell in the second SIM (SIM 2) is greater than a threshold value.

The DSDS controller also monitors the SIM 2 GSM cell while SIM 2 uses the RF resource for performing neighbour cell measurements. While monitoring, the DSDS controller waits for one of a plurality of events to occur in the SIM 2 GSM cell, at operation 324. The events comprise at least one of a handover parameter, a re-establishment with the serving cell, and an event where SIM 2 leaves the connected (CONN) mode with the current serving GSM cell. Once any of the events occur in SIM 2, the DSDS controller determines whether new measurements are available from the network at operation 326. According to example embodiments, operation 326 by which the DSDS controller determines whether new measurements are available is referred to as a post-connection event measurement check). If the DSDS controller determines that new measurements are available, the process returns to operation 306 and neighbour cell measurement restrictions are performed on the SIM 2 GSM stack. If it is determined at operation 326 that measurement results are not available, the DSDS controller waits a period of time before checking again. By this process, the DSDS controller allows SIM 1 to use the RF resource for a longer time thereby enhancing data performance in SIM 1. Further, the DSDS controller helps to reduce power consumption in the DSDS device by allowing only one of the two SIMs to be in an active state at one time.

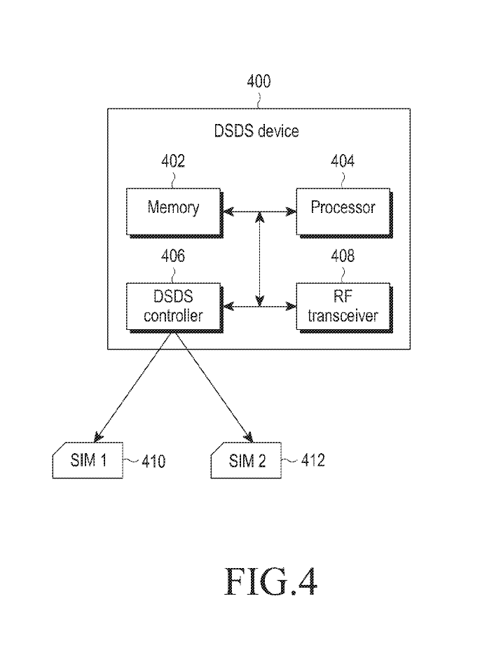

FIG. 4 is a block diagram illustrating one or more functional components of a DSDS device 400, according to example embodiments. DSDS device 400 includes a processor 404, a memory 402, a RF transceiver 408 and a DSDS controller 406. DSDS controller 406 is operatively coupled to two SIMs namely SIM 410 (SIM 1) and SIM 412 (SIM 2). DSDS device 400 may also include additional components such as an antenna (not shown for the purpose of clarity of the illustration).

Memory 402 stores instructions to be executed by processor 404. In example embodiments, the memory may include a random access memory (RAM), a read only memory (ROM), another type of dynamic or static storage device, a removable memory card, and/or another type of memory that may store information and instructions for execution by processor 404.

Processor 404 is configured to execute instructions stored in memory 402. Processor 404 may include one or more of a microprocessor, a controller, a digital signal processor (DSP), an application specific integrated circuit (ASIC), a field-programmable gate array (FPGA), or equivalent discrete or integrated logic circuitry. Additionally, the functions attributed to processor 404, in this disclosure, may be embodied as software, firmware, hardware or any combination thereof.

DSDS controller 406 is configured to enhance data performance in DSDS device 400. In example embodiments, DSDS controller 406 may work as a microprocessor for monitoring the occurrence of one or more conditions for enabling and disabling neighbour cell measurements in SIM 412, while a data session is active in SIM 410. The one or more conditions for enabling and disabling neighbour cell measurements are explained in detail in association with FIG. 3 and hence not explained further here. In example embodiments, the conditions for enabling and disabling neighbour cell measurements are stored in the DSDS controller. In example embodiments, the conditions are stored in memory 402. In these example embodiments, the DSDS controller interacts with memory 402 to fetch information associated with enabling and disabling neighbour cell measurements in SIM 412. When a data session is ongoing in SIM 410, DSDS controller 406 checks whether a request for RF resources is received from SIM 412. DSDS controller 406 checks whether enabling or disabling conditions are met in SIM 412. Accordingly, DSDS controller 406 performs one or more actions based on whether the enabling or disabling conditions are met in SIM 412.

RF transceiver 408 is configured to enable DSDS device 400 to communicate with other devices or systems in the network through SIM 410 and SIM 412. In DSDS device 400, RF transceiver 408 is separately shared by SIM 410 and SIM 412 for establishing communication with their respective networks. RF transceiver 408 communicates with the networks using any of the mobile communication technologies such as 3G, 4G, time division multiple access (TDMA), code division multiple access (CDMA), and the like. For example, RF transceiver 408 helps DSDS device 400 to communicate with a LTE (4G) network for availing data services from the LTE network through SIM 410. For SIM 412, RF transceiver 408 helps DSDS device 400 to communicate with a GSM (2G) network to avail circuit switched services from the network. It is to be noted that SIM 410 may be configured to operate on other networks such as 2G and CDMA; likewise, SIM 412 may be configured to operate on LTE, 3G and other mobile networks.

In the preceding detailed description of the example embodiments of the invention, reference is made to the accompanying drawings that form a part hereof, and in which are shown by way of illustration example embodiments in which the invention may be practiced. These example embodiments are described in sufficient detail to enable those skilled in the art to practice the invention, and it is to be understood that other example embodiments may be utilized and that changes may be made without departing from the scope of the present invention. The following detailed description is, therefore, not to be taken in a limiting sense, and the scope of the present invention is defined only by the appended claims.

What is claimed is:

1. A method for operating by a dual subscriber identification module (SIM) dual standby (DSDS) device including a first SIM and a second SIM, the method comprising:
determining whether one or more entry conditions for restricting a use of the second SIM used to perform neighbour cell search and measurement operations are detected when the first SIM is used to perform data communication;
imposing restrictions on the use of the second SIM in response to detecting the one or more entry conditions;
determining whether one or more exit conditions to remove the restrictions on the use of the second SIM are detected; and
removing the restrictions on the use of the second SIM in response to detecting the one or more exit conditions;
wherein while the restrictions are imposed on the use of the second SIM, the first SIM is used to the data communication using a radio frequency (RF) resource that is shared for the first SIM and the second SIM.

2. The method of claim 1, wherein the one or more entry conditions for restricting the use of the second SIM include at least one of:
a first condition that the first SIM is used in a connected mode to perform data transfer operations;
a second condition that the first SIM is used in a connected mode while a data transfer speed is above a first threshold value;
a third condition that the second SIM is used while a signal strength of a serving cell greater than a second threshold value; and
a fourth condition that the first SIM includes information configured by a network with measurement including a network identity associated with the first SIM or the second SIM.

3. The method of claim 1, wherein the imposing of restrictions on the use of the second SIM comprising:
imposing the restrictions on the use of the second SIM in response to detecting a signal strength of a serving cell associated with the second SIM is greater than a threshold value and an additional RF resource is required to perform a data transfer associated with the first SIM.

4. The method of claim 1, wherein the one or more exit conditions to remove the restrictions on the use of the second SIM include at least one of:
a first condition that an idle mode is entered after completing a data transfer operation using the first SIM;
a second condition that a data transfer speed is below a first threshold value in a connected mode using the first SIM;
a third condition that a signal strength of a serving cell associated with the second SIM is less than a second threshold value;
a fourth condition that a serving cell measurement event is triggered on the first SIM for a network or cell measurement identities (IDs) added by the network in a measurement configuration;
a fifth condition that a change in a cell ID occurring due to a handover or redirection operation associated with the first SIM; and
a sixth condition that a threshold time being exceeded by a duration during which the restrictions are imposed on the use of the second SIM.

5. The method of claim 1, wherein the first SIM and the second SIM are configured to operate on at least one of:
a global system for mobile communication (GSM) network,
a universal mobile telecommunications system (UMTS) network,
a long term evolution (LTE) network, and
an LTE-advanced (4G) network.

6. A dual subscriber identification module (SIM) dual standby (DSDS) device, the DSDS device comprising:
a memory;
a first SIM configured to store information for availing first services from a first network;
a second SIM configured to store information for availing second services from a second network; and
a controller operatively coupled to the memory, the first SIM and the second SIM, and the controller configured to:
determine whether one or more entry conditions for restricting a use of the second SIM used to perform neighbour cell search and measurement operations are detected when the first SIM is used to perform data communication related to the first network;
impose restrictions on the use of the second SIM in response to detecting the one or more entry conditions;
determine whether one or more exit conditions to remove the restrictions on the use of the second SIM are detected; and
remove the restrictions on the use of the second SIM in response to detecting the one or more exit conditions;
wherein while the restrictions are imposed on the use of the second SIM, the first SIM is used to the data communication using a radio frequency (RF) resource that is shared for the first SIM and the second SIM.

7. The DSDS device of claim 6, wherein the one or more entry conditions for restricting the use of the second SIM include at least one of:
a first condition that the first SIM is used in a connected mode to perform data transfer operations;
a second condition that the first SIM is used in a connected mode while a data transfer speed is above a first threshold value;
a third condition that the second SIM is used while a signal strength of a serving cell greater than a second threshold value; and
a fourth condition that the first SIM includes information configured by a network with measurement including a network identity associated with the first SIM or the second SIM.

8. The DSDS device of claim 6, wherein the one or more exit conditions to remove the restrictions on the use of the second SIM include at least one of:
a first condition that an idle mode is entered after completing a data transfer operation using the first SIM;
a second condition that a data transfer speed is below a first threshold value in a connected mode using the first SIM;
a third condition that a signal strength of a serving cell associated with the second SIM is less than a second threshold value;
a fourth condition that a serving cell measurement event is triggered on the first SIM for a network or cell measurement identities (IDs) added by the network in a measurement configuration;
a fifth condition that a change in cell ID occurring due to a handover or redirection operation associated with the first SIM; and
a sixth condition that a threshold time being exceeded by a duration during which the restrictions are imposed on the neighbour cell search and measurement operations of the second SIM.

9. A method for operating by a dual subscriber identification module (SIM) dual standby (DSDS) device including a first SIM and a second SIM, the method comprising:
detecting whether a signal strength of a serving cell associated with the second SIM is greater than a threshold value when the first SIM is used to perform data communication with a first network;
imposing restrictions on a use of the second SIM used to perform neighbour cell search and measurement operations in response to detecting the signal strength of the serving cell is greater than the threshold value;
detecting whether the first SIM is in an idle state;
removing the restrictions on the use of the second SIM in response to detecting the first SIM is in the idle state; and
wherein while the restrictions are imposed on the use of the second SIM, the first SIM is used to the data communication using a radio frequency (RF) resource that is shared for the first SIM and the second SIM.

10. The method of claim 9, further comprising:
performing a non-idle measurement check to determine whether first measurement results related to first cell measurement operation are available for the first SIM, in response to detecting the first SIM is not in the idle state.

11. The method of claim 10, further comprising:
determining whether a measurement identity (ID) related to the first cell measurement operation is configured for one of the first network and a second network associated with the second SIM, based on the non-idle measurement check.

12. The method of claim 11, further comprising:
determining whether an event is triggered to perform measurement on a cell corresponding to the measurement ID, in response to determining the measurement ID is configured for one of the first network and the second network.

13. The method of claim 12, further comprising:
removing the restrictions on the use of the second SIM, in response to detecting the event is triggered to perform the measurement on the cell corresponding to the measurement ID.

14. The method of claim 13, further comprising:
detecting whether at least one of connection events occurs while the restrictions are not imposed on the use of the second SIM, the events including a first event that a handover parameter is received, a second event that a connection with the serving cell is re-established, and a third event that the connection with the serving cell is maintained.

15. The method of claim 14, further comprising:
performing a post-connection event measurement check to determine whether second measurement results related to a second cell measurement operation are available for the first SIM, in response to detecting the at least one of the connection events has occurred.

16. The method of claim 15, further comprising:
re-imposing the restrictions on the use of the second SIM, based on a result of the post-connection event measurement check.

17. The method of claim 11, further comprising:
performing a post-configuration measurement check to determine whether third measurement results related to a third cell measurement operation are available for the first SIM or the second SIM, in response to determining the measurement ID is not configured for one of the first network and the second network.

18. The method of claim 12, further comprising:
performing a post-configuration measurement check to determine whether third measurement results related to a third cell measurement operation are available for the first SIM or the second SIM, in response to determining no event is triggered to perform the measurement on the cell corresponding to the measurement ID.

19. The method of claim 17, further comprising:
detecting whether the signal strength of the serving cell is greater than the threshold value, based on a result of the post-configuration measurement check.

20. The method of claim 9, wherein the first SIM and the second SIM are configured to operate on at least one of:
a global system for mobile communication (GSM) network,
a universal mobile telecommunications system (UMTS) network,
a long term evolution (LTE) network, and
an LTE-advanced (4G) network.
